(19) United States
(12) Patent Application Publication
(10) Pub. No.: US 2006/0271455 A1
(43) Pub. Date: Nov. 30, 2006

(54) Method and apparatus for management of intellectual capital

(75) Inventors: James Richard Lavoie, Voluntown, CT (US); Ian Mitchell, Portsmouth, RI (US); Thomas Santos, Middletown, RI (US); Donald L. Stanford, St. Thomas, VI (US)

Correspondence Address: Ryan, Mason & Lewis, LLP, Suite 205, 1300 Post Road, Fairfield, CT, 06824, US

(73) Assignee: Rite-Solutions, Inc., Pawcatuck, CT (US)

(21) Appl. No.: 11/138,748

(22) Filed: May 26, 2005

(51) Int. Cl. G06Q 40/00

(52) U.S. Cl. 705/35

(57) ABSTRACT

Methods and apparatus are disclosed for management of intellectual capital in an enterprise. The disclosed investment capital management tool obtains a description of a plurality of innovations of the enterprise; provides the descriptions to a plurality of employees; allows the plurality of employees to invest a pool of investment units in one or more of the plurality of innovations; and prioritizes the plurality of innovations based on the investments. In addition, the disclosed investment capital management tool can obtain a description of a plurality of innovations of the enterprise; provides the descriptions to a plurality of employees; allows the plurality of employees to record contributions to the innovations in records associated with the description; and provides the descriptions and an indication of the corresponding contributions to a plurality of employees.

### FIELD OF THE INVENTION

The present invention relates generally to enterprise management systems and more particularly, to methods and apparatus for recording, managing and evaluating intellectual capital.

### BACKGROUND OF THE INVENTION

As corporate employees become increasingly distributed in time or location (or both), it becomes important to maintain a sense of community. It is difficult for employees working in remote sites to remain “connected” with their colleagues in other locations, to participate in discussions and evaluations of ideas with their colleagues, and to identify colleagues that share common interests. The challenges for new employees at such remote locations to become integrated into the corporate environment are even greater.

In many corporate environments, the development of innovation and ideas takes a “top down” approach, where senior employees primarily initiate and evaluate potential innovations. In addition, when discussing and evaluating such innovations, there is a tendency for senior employees to turn to their own network of trusted friends and advisers, which are typically other senior employees. It has been consistently found, however, that employees at all levels wish to contribute to company initiatives.

A need therefore exists for an automated system and method that provide a centralized forum for a discussion and evaluation of ideas and allows employees working in remote sites to remain “connected” with their colleagues in other locations and to identify colleagues that share common interests.

### SUMMARY OF THE INVENTION

Generally, methods and apparatus are provided for management of intellectual capital in an enterprise. The disclosed investment capital management tool provides a centralized forum for discussing and evaluating ideas and allows employees working in remote sites to remain “connected” with their colleagues in other locations and to identify colleagues that share common interests.

According to one aspect of the invention, the disclosed investment capital management tool obtains a description of a plurality of innovations of the enterprise; provides the descriptions to a plurality of employees; allows the plurality of employees to invest a pool of investment units in one or more of the plurality of innovations; and prioritizes the plurality of innovations based on the investments.

According to another aspect of the invention, the disclosed investment capital management tool obtains a description of a plurality of innovations of the enterprise; provides the descriptions to a plurality of employees; allows the plurality of employees to record contributions to the innovations in records associated with the description; and provides the descriptions and an indication of the corresponding contributions to a plurality of employees.

A more complete understanding of the present invention, as well as further features and advantages of the present invention, will be obtained by reference to the following detailed description and drawings.

### BRIEF DESCRIPTION OF THE DRAWINGS

FIG. 1 illustrates a network environment in which the present invention can operate;

FIG. 2 is a schematic block diagram of an exemplary investment capital management tool server incorporating features of the present invention;

FIG. 3 is a sample template for an exemplary stock description document;

FIG. 4 is a sample table from an exemplary stock database of FIG. 2;

FIG. 5 is a sample table from an exemplary user database of FIG. 2;

FIG. 6 is an exemplary user interface for the intellectual capital assessment tool;

FIG. 7 is an exemplary user interface for presenting a user with his or her portfolio of stocks currently held by the user;

FIG. 8 is a flow chart describing an exemplary implementation of an initial stock offering process incorporating features of the present invention; and

FIG. 9 is a flow chart describing an exemplary implementation of a stock valuation process incorporating features of the present invention.

### DETAILED DESCRIPTION

The present invention provides an automated system and method that provide a centralized forum for a discussion and evaluation of ideas. The disclosed intellectual capital management tool helps innovative ideas within an enterprise to percolate within the organization as opposed to being generated and evaluated with a “top down” approach. Among other benefits, the intellectual capital management tool encourages employees to document innovations (i.e, complete disclosure) in the intellectual capital management tool so that they can be evaluated by their colleagues. The repository of information allows new employees to efficiently learn about the company and various projects and other innovations within the company. In addition, the repository of information allows existing employees to efficiently learn about new projects and other innovations within the company.

The present invention allows employs to identify colleagues that share common interests. In addition, employee interests and talents are aligned in a coordinated way to produce positive outcomes.

According to one aspect of the present invention, the intellectual capital management tool includes an intellectual capital assessment tool, also referred to as “Mutual Fun,” that allows employees to invest in one or more innovations of the enterprise based on the perceived value of each innovation. In one exemplary implementation, innovations are categorized into a number of areas, such as technology, business and business process improvements.

As discussed hereinafter, the intellectual capital assessment tool includes features that allow employees to research and evaluate each innovation in order that they can make an educated investment. The individual investments of an employee give the employee a voice in prioritizing enterprise efforts towards innovations and the aggregate employee investments provide a dynamic barometer of the perceived value of each innovation. In this manner, the intellectual capital assessment tool provides the enterprise with a relative assessment of each innovation, based on the employee investments, which may be used to guide the pursuit of each innovation. For example, each employee may be given a fixed amount of real or virtual money to invest in each innovation listed on the intellectual capital assessment tool. While the exemplary embodiment assumes that each employee has an equal amount of “money” to invest, various weight schemes can be employed, as would be apparent to a person of ordinary skill. For example, the shares of a given employee can be weight based on prior success or in accordance with a corporate hierarchy.

According to another aspect of the invention, an intellectual capital investment tool allows employees to invest their time and efforts in the innovations of the enterprise. The intellectual capital investment tool allows employees to record efforts they have made toward advancing a given innovation (i.e., to advance the value of a given innovation). The intellectual capital investment tool allows fosters the generation, documentation and development of ideas in an enterprise. It also provides a mechanism for virtual collaboration among remote colleagues.

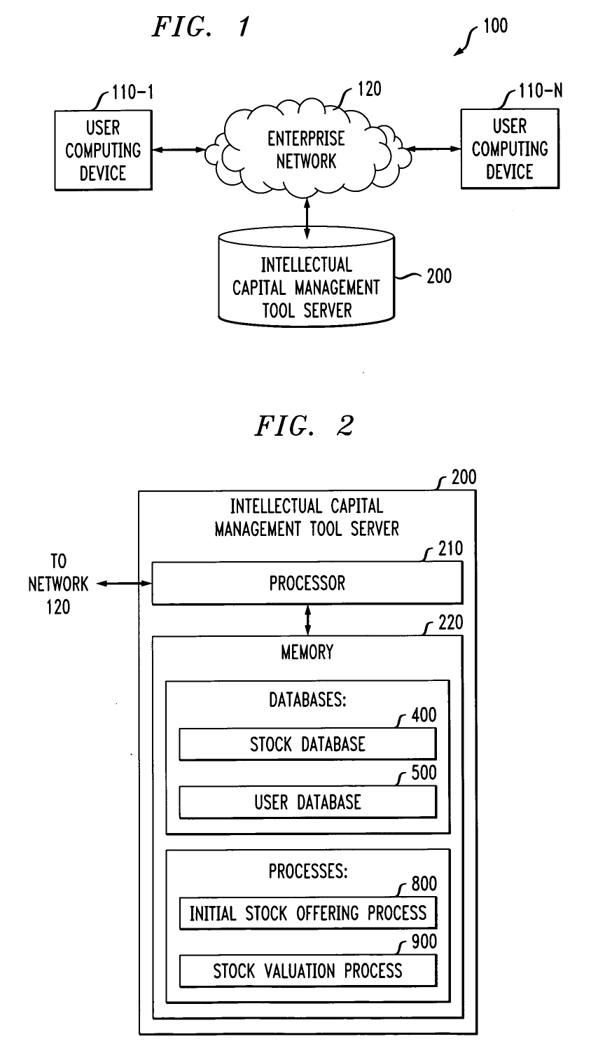

FIG. 1 illustrates a network environment 100 in which the present invention can operate. As shown in FIG. 1, one or more users, such as the employees of an enterprise, employ user computing devices 110-1 through 110-N, to communicate over a network 120 with an investment capital management tool server 200, discussed below in conjunction with FIG. 2. The network 120 may be embodied as any private or public wired or wireless network, including the Public Switched Telephone Network, a Private Branch Exchange switch, Internet, or cellular network, or some combination of the foregoing. While the present invention is illustrated using a server side implementation, where the features of the present invention are resident on the investment capital management tool server 200, the features and functions of the present invention may be deployed on a number of distributed computers, as well as on a client associated with one or more user computing devices 110-1 through 110-N, or a combination of the foregoing, as would be apparent to a person of ordinary skill in the art.

FIG. 2 is a schematic block diagram of an exemplary investment capital management tool server 200 incorporating features of the present invention. The investment capital management tool server 200 may be any computing device, such as a personal computer, work station or server. As shown in FIG. 2, the exemplary investment capital management tool server 200 includes a processor 210 and a memory 220, in addition to other conventional elements (not shown). The processor 210 operates in conjunction with the memory 220 to execute one or more software programs. Such programs may be stored in memory 220 or another storage device accessible to the investment capital management tool server 200 and executed by the processor 210 in a conventional manner.

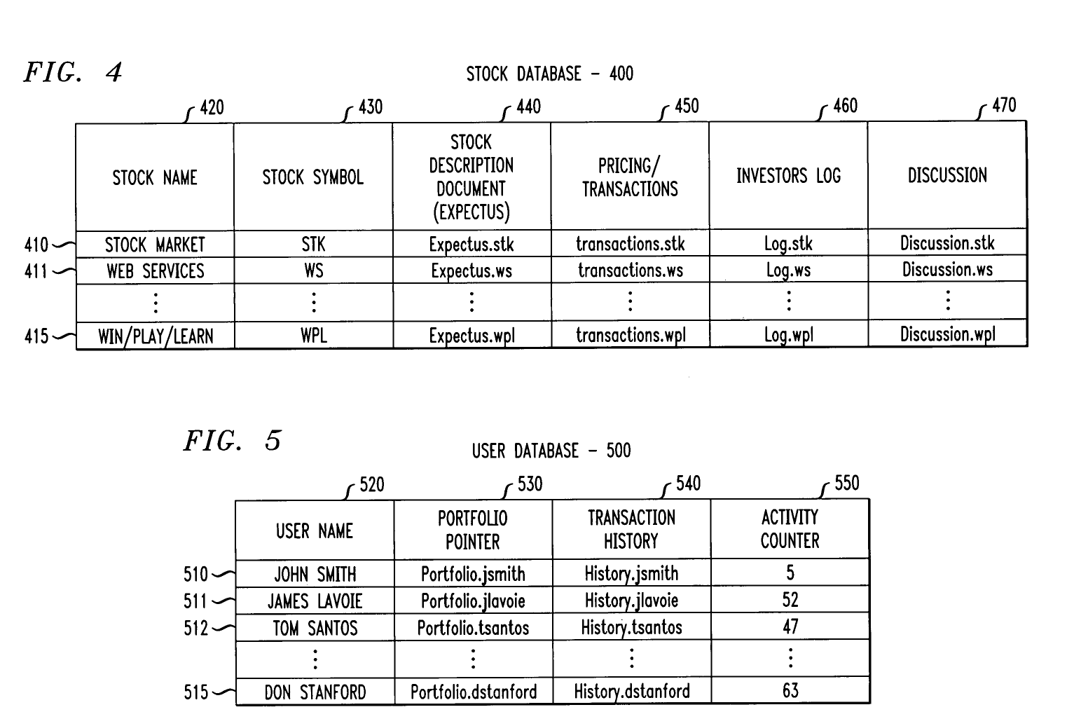

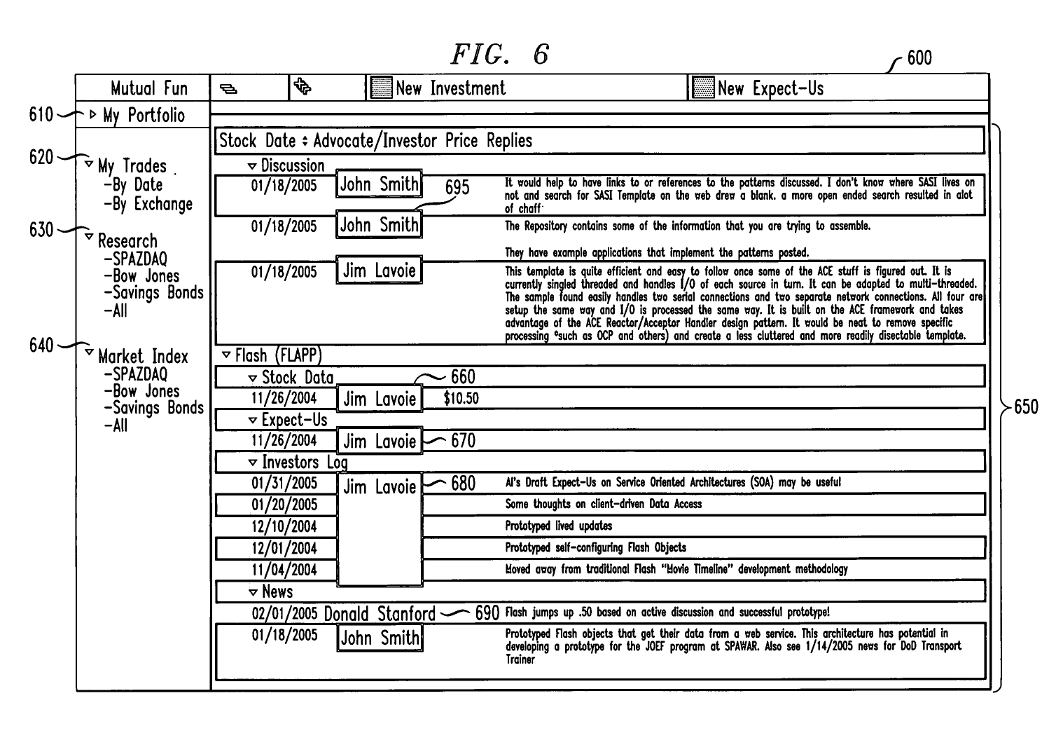

For example, as discussed below in conjunction with FIGS. 4 and 5, the memory 220 may store a stock database 400 and a user database 500, respectively. Generally, the stock database 400 records information about each available stock and the user database 500 contains information about each user or investor.

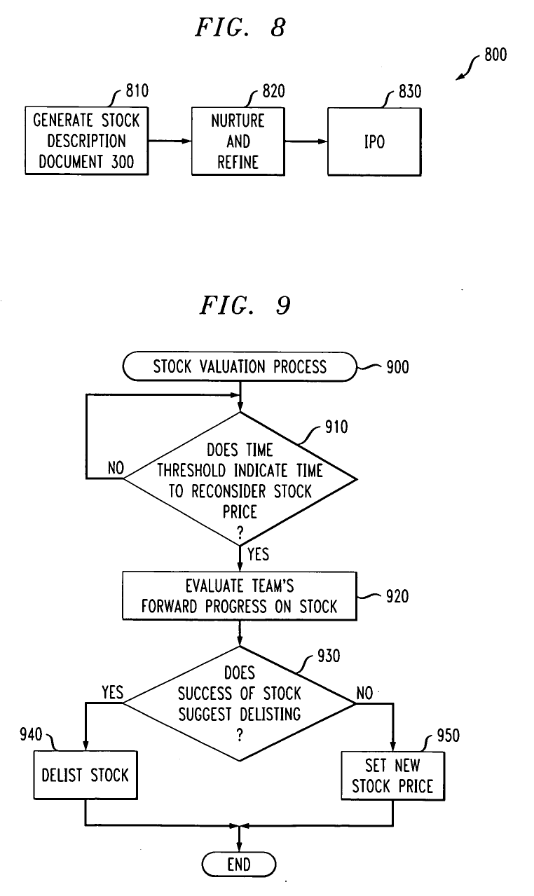

In addition, the memory 220 may store an initial stock offering process 800 and a stock valuation process 900 incorporating features of the present invention, as discussed further below in conjunction with FIGS. 8 and 9. Generally, the initial stock offering process 800 monitors and records the development of an idea from the initial conception through listing on the stock market. The stock valuation process 900 monitors the development of a given innovation and sets an appropriate market price.

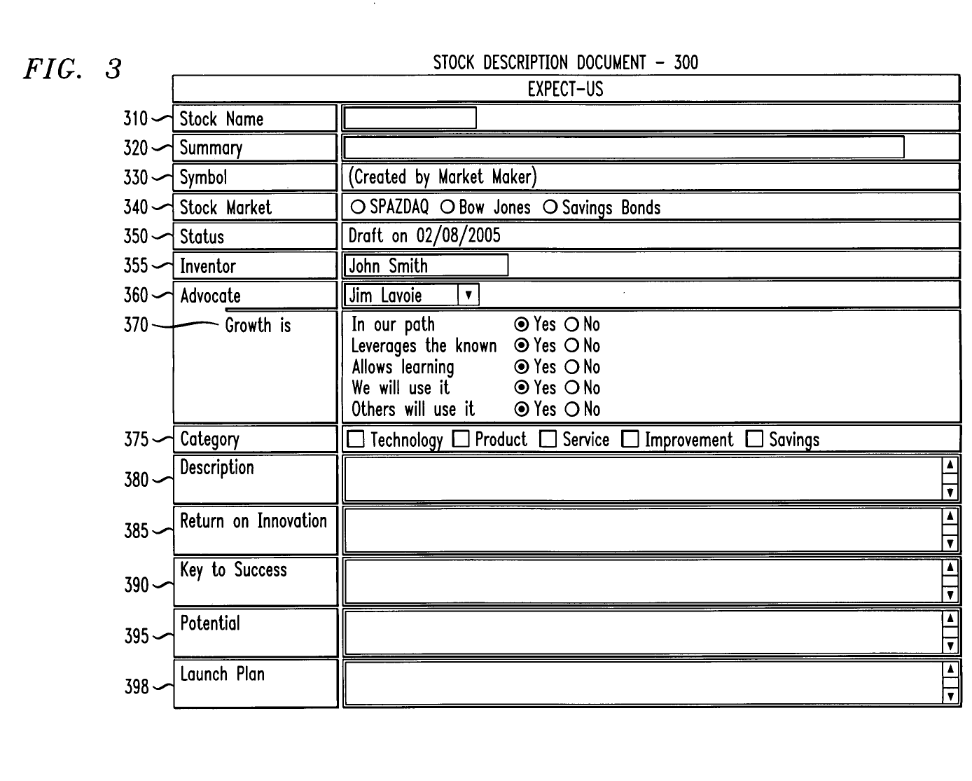

FIG. 3 is a sample template for an exemplary stock description document 300 (also referred to as an “expect-us”). The stock description document 300 allows an employee with a new idea or innovation to enter information describing the new innovation (i.e., the new stock) so that it may be recorded in the intellectual capital assessment tool. Every listed stock has a published stock description document 300 that is available for viewing by any participant in the Stock Market. As discussed hereinafter, generation of the stock description document 300 is the first step in having a stock listed on the stock market. The collection of stock description documents 300 for the various innovations of an enterprise provide a valuable resource for anyone (with appropriate authorization to access the investment capital management tool server 200) to research the various innovations of the enterprise.

As shown in FIG. 3, the exemplary stock description document 300 contains a field 310 that records the name of the innovation (i.e., stock); a field 320 that provides a summary description of the idea; and a field 330 identifying the symbol for the stock. If the enterprise maintains more than one stock market, field 340 identifies the appropriate stock market for the innovation. The current status of the innovation is indicated in field 350. For example, an innovation can have a status of draft, listed, or delisted (successful launch of innovation). The inventor of the innovation is listed in field 355 and the advocate of the innovation is listed in field 360. In this manner, by completing a stock description document 300, a user can submit their idea for consideration by the enterprise at large.

The role of an advocate is to help or mentor more junior employees; be a leader of stock initiatives; guide investment activity when asked; inform the market maker of news worthy items; ask for help when a stock team needs it; and foster discussions within/across stocks. Generally, the market maker is an unbiased person who nurtures the stock market process; works with employees who want to participate at any level; identifies areas for improvement in the process; offers constructive help to Advocates and Investors in achieving their stock description document goals; collaborates with others to advance innovations;

The stock description document 300 also contains a growth flag in field 370 characterizing how the enterprise will use the stock for growth of the enterprise. A category flag in field 375 associates the innovation with one or more predefined categories. Field 380 contains a description of the stock. Field 385 describes how the innovation will provide a return to the enterprise, such as whether the innovation has value if adopted by others or if it will provide a revenue stream if licensed by others. Field 390 identifies factors that are key to the success of the innovation, such as employee interest, ease of use, and acceptance by management. The financial potential of the innovation and a launch plan are identified in fields 395 and 398, respectively.

FIG. 4 is a sample table from an exemplary stock database 400. As previously indicated, the stock database 400 records information about each available stock. The stock database 400 contains a number of records 410-415, each corresponding to a different stock. As shown in FIG. 4, for each stock identified by name and symbol in fields 420 and 430, the stock database 400 provides a pointer to the corresponding stock description document 300 in field 440, a pointer to pricing information in field 450, a pointer to an investor's log in field 460 and a pointer to a discussion forum in field 470.

Generally, as discussed further below in conjunction with FIG. 6, the investor's log identified in field 460 allows employees who have contributed to the advancement of an innovation to record their contribution. In this manner, other employees and management can monitor the advancement of each innovation and collaborate on someone else's idea. In addition, the discussion forum identified in field 470 (and also shown in FIG. 6) allows interested parties to comment on the innovation, for example, using a chat or bulletin board type mechanism.

In this manner, if an employee evaluates a stock idea or a stock description document 300 that interests them, then the employee should contact the Advocate for that stock to express a desire to invest in the real sense. This type of investment involves contributing to the actualization of the idea underlying the stock. The ability of a stock to attract intellectual collaboration from the members of the enterprise is an important component of the idea engine provided by the intellectual capital assessment tool. The ability of an employee to become an investor in a stock is based on the employee's interest or passion and his or her available time. In effect, the employee becomes a member of that stock team when he or she makes a commitment to invest at this level.

It is also important for employees to contribute when they have something to say that may help a stock team move forward towards its stated goals in the stock description document 300. A contributor participates at a more casual and ad hoc level than an investor but may have insight into success factors for a stock that are very valuable and worthwhile. As discussed herein, every stock has a discussion board that is open for contributions and of course, contributors are encouraged to engage inventors, investors or Advocates directly if needed.

Of course, being an investor in certain stocks and a contributor in others is not mutually exclusive. It is hoped that many employees will participate at both levels whenever possible.

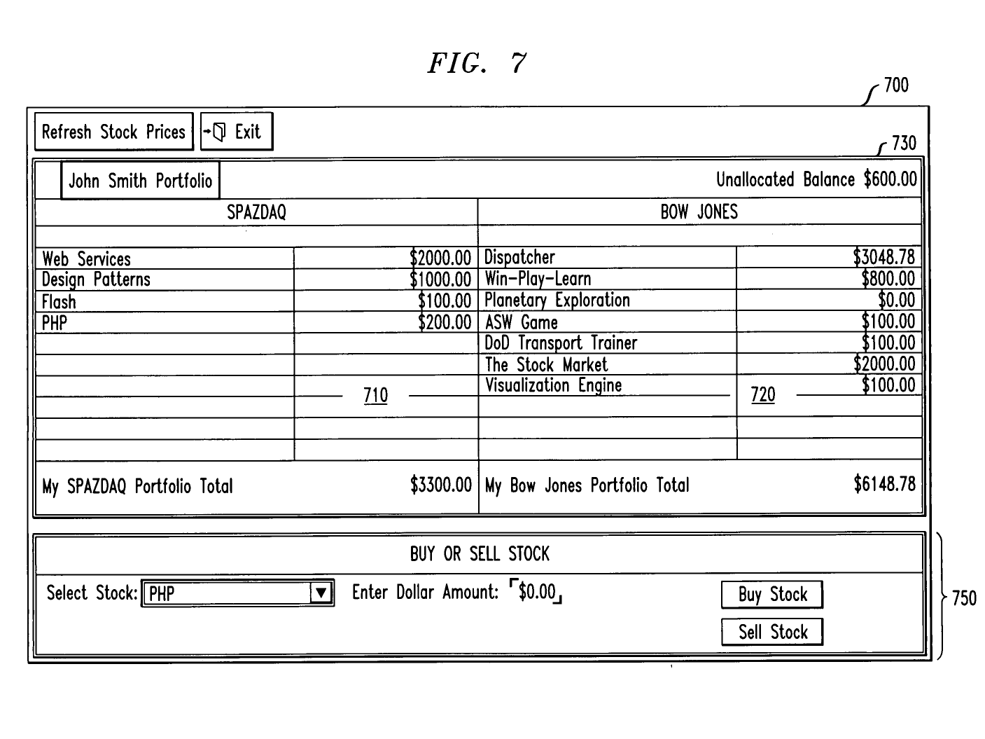

FIG. 5 is a sample table from an exemplary user database 500. As previously indicated, the user database 500 contains information about each user or investor. The user database 500 contains a number of records 510-515, each corresponding to a different user. As shown in FIG. 5, for each user identified by name in field 520, the user database 500 provides a pointer in field 530 to the portfolio of current stocks held by the user, discussed below in conjunction with FIG. 7, a pointer in field 540 to the historical transactions of the user and an activity counter in field 550 that counts, for example, the number of system log-ons or transactions of the user.

FIG. 6 is an exemplary user interface 600 for the intellectual capital assessment tool. As shown in FIG. 6, the exemplary user interface 600 provides a graphical link 610 that allow a user to access his or her portfolio 700, discussed below in conjunction with FIG. 7; a graphical link 620 that allow a user to access his or her historical trades, for example, sorted by date or stock exchange; a graphical link 630 that allow a user to access research tools to assist in making investment decisions, for example, by exchange; and a graphical link 640 that allow a user to access market indexes for each exchange to evaluate current or historical pricing of stocks.

The primary window 650 of the exemplary user interface 600 illustrates exemplary information presented to the user when one of the graphical links 630 has been selected that allow a user to access research tools to assist in making investment decisions. For example, the window 650 illustrates exemplary information for a stock having a symbol “FLAPP.” As shown in FIG. 6, the window 650 presents the user with current price information in a field 660, a link to the stock description document 300 for the stock in field 670, the investor's log in field 680 and news in field 690. As previously indicated, the investor's log identified in field 460 allows employees who have contributed to the advancement of an innovation to record their contribution. In this manner, other employees and management can monitor the advancement of each innovation.

In addition, as shown in FIG. 6, information presented in window 650 for a given stock may also contain a discussion forum 695. The discussion forum 695 allows interested parties to comment on the innovation, for example, using a chat or bulletin board type mechanism. In this manner, the intellectual capital assessment tool provides a mechanism for facilitating discussion of innovations, rather than relying on individuals to have a discussion if they happen to see each other, for example, in hallway.

FIG. 7 is an exemplary user interface 700 for presenting a user with his or her portfolio of stocks currently held by the user. As shown in FIG. 7, the exemplary user interface 700 presents a user with a number of windows, such as windows 710, 720, each identifying the stocks held by the user in a given stock exchange. In addition, a field 730 indicates the current cash balance of the user that is remaining to invest in one or more stocks. Finally, the user interface 700 includes a window 750 that allows a user to buy or sell a stock. It is noted that another interface can be presented to the user to analyze and access transactions by date or exchange.

FIG. 8 is a flow chart describing an exemplary implementation of an Initial Stock Offering Process 800 incorporating features of the present invention. As previously indicated, the initial stock offering process 800 monitors and records the development of an idea from the initial conception through listing on the stock market. As shown in FIG. 8, the Initial Stock Offering Process 800 is initiated during step 810 upon generation by an inventor or another employee of a stock description document 300. Thereafter, the stock is nurtured and refined during step 820 until it is ready for its “initial public offering” during step 830.

Generally, the market maker or one or more other designated persons determines if the invention described in the stock description document 300 describes an invention that is suitable for the enterprise to pursue. For example, the market maker may determine if the invention fits within the corporate plan. It is important that the inventions listed on the intellectual capital assessment tool are filtered so as not to dilute the value of other inventions, or to overwhelm the employees with too many frivolous inventions.

Proposals will proceed to step 830 as a result of a nurturing process that may measure, for example, feasibility, applicability and potential. This nurturing process may involve a subjective decision by one or more people, or be based on more objective criteria, such as a committee vote. If an invention is listed on the stock market during step 830, the invention becomes eligible, for example, for funding by the enterprise and participation by other collaborators and the project is listed on the market board for investment by other employees. Generally, each stock will have a uniform initial price, such as $10.00 per share.

An invention that is listed on the stock market during step 830 is acknowledged to have demonstrated potential for return on innovation. It is up to the inventor, the advocate and their investors and contributors (as well as other interested parties) to provide the ingredients to realize the potential that was proposed in the stock description document 300. Over the course of events, the price of a stock in the Mutual Fun portfolio will be adjusted using the Stock Valuation Process 900 of FIG. 9 to reflect progress for each stock.

FIG. 9 is a flow chart describing an exemplary implementation of a Stock Valuation Process 900 incorporating features of the present invention. As previously indicated, the Stock Valuation Process 900 monitors the development of a given innovation and sets an appropriate market price. As shown in FIG. 9, the exemplary Stock Valuation Process 900 considers stock price reevaluation at periodic intervals. It is noted, however, that a more ad hoc approach to pricing can also employed, such as adjusting a price upon a significant event.

The Stock Valuation Process 900 performs a test during step 910 to determine if a time threshold has expired. If it is determined during step 910 that the time threshold has not expired, then program control returns to step 910. If, however, it is determined during step 910 that the time threshold has expired, then the team's forward progress on the stock is evaluated during step 920. For example, forward progress might include demonstrations or prototypes of the invention, simulations, a presentation to a potential customer or standards body, or success in the marketplace.

A further test is performed during step 930 to determine if the success of the stock suggests a delisting. If it is determined during step 930 that the stock should be delisted, then program control proceeds to step 940. If, however, it is determined during step 930 that the stock should not be delisted, then a price analysis is performed during step 950. For example, a stock may be automatically delisted upon a product launch (success) or if it is inactive for a given duration (implicit failure). When a stock realizes its return on innovation (objectives as set forth in the corresponding stock description document 300), the stock can be cashed out. This event triggers its removal or delisting and frees up the game money that has been invested by employees for re-allocation by all of the players into other listed stocks. When a stock reaches this stage, it is returning value in some form to the Company.

In a similar manner, a stock that fails to achieve its objectives or loses its potential for return on innovation may be de-listed based, for example, on a consensus between the market makers and the advocates.

For a more detailed description of stock market terminology and processes, see, for example, George A. Fontanills, et al., The Stock Market Course (Wiley & Sons, 2001) or David Cash, Stock Market Basics (ISBN 0967274508), each incorporated by reference herein.

In a further variation, the investment capital management tool server 200 can provide a due diligence tool that allows an outside customer, investor or another authorized and interested party to evaluate the intellectual property of an enterprise. For example, the investment capital management tool server 200 can allow a person to review archived information about the enterprise and its intellectual property.

In yet another variation, the investment capital management tool server 200 can provide a compound interest function that provides a notification mechanism for investors and users to be notified whenever an investment has been made to a given stock. For example, all investors to a stock can be automatically notified (e.g., via email) whenever an investment has been made to a given stock. When an investor makes a contribution or investment to a stock, the investment capital management tool server 200 will automatically add that stock to the profile of the investor. This feature will enhance collaboration and cooperation among investors by ensuring that all interested parties are notified with up-to-date information and activities associated with a stock in their profile.

In addition, individuals who have not contributed or made an investment in a stock may nonetheless be interested in the progress of a stock. To encourage and support this interest, the investment capital management tool server 200 can allow a user to manually add “stocks of interest” to their profile. In this manner, whenever an investment is made to a stock in their investor profile, the user will be automatically notified.

System and Article of Manufacture Details

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

We claim:

1. A method for managing intellectual capital in an enterprise, comprising:
obtaining a description of a plurality of innovations of said enterprise;
providing said descriptions to a plurality of employees;
allowing said plurality of employees to invest a pool of investment units in one or more of said plurality of innovations; and
prioritizing said plurality of innovations based on said investments.

2. The method of claim 1, wherein said investments provide an indicator of a potential return on innovation.

3. The method of claim 1, wherein said investments provide an indicator of one or more innovations that should be pursued by said enterprise.

4. The method of claim 1, wherein said investments provide an indicator of a common interest by a plurality of said employees.

5. The method of claim 1, further comprising the step of identifying an interest group based on said investments.

6. The method of claim 1 wherein said investments allow one or more of employee interests or talents to be aligned

7. The method of claim 1, wherein said method is employed as a training tool for a new employee.

8. The method of claim 1, further comprising the step of providing an indication of said investments to employees of said enterprise.

9. A method for managing intellectual capital in an enterprise, comprising:
obtaining a description of a plurality of innovations of said enterprise;
providing said descriptions to a plurality of employees;
allowing said plurality of employees to record contributions to said innovations in records associated with said description; and
providing said descriptions and an indication of said corresponding contributions to a plurality of employees.

10. The method of claim 9, wherein said recorded contributions provide an indicator of a potential return on innovation.

11. The method of claim 9, wherein said recorded contributions provide an indicator of one or more innovations that should be pursued by said enterprise.

12. The method of claim 9, wherein said recorded contributions provide an indicator of a common interest by a plurality of said employees.

13. The method of claim 9, further comprising the step of identifying an interest group based on said recorded contributions.

14. The method of claim 9, wherein said method is employed as a training tool for a new employee.

15. The method of claim 9, wherein a price is assigned to each of said innovations by a market maker based on said recorded contributions.

16. The method of claim 9, further comprising the step of providing an indication of said recorded contributions to employees of said enterprise.

17. The method of claim 9, wherein said recorded contributions provide a storage of linked competency.

18. The method of claim 9, wherein said recorded contributions are automatically categorized with an associated innovation.

19. The method of claim 9, further comprising the step of notifying one or more users of activity related to said innovations based on a profile of said one or more users.

20. A system for managing intellectual capital in an enterprise, comprising:
a memory; and
at least one processor, coupled to the memory, operative to:
obtain a description of a plurality of innovations of said enterprise;
provide said descriptions to a plurality of employees;
allow said plurality of employees to invest a pool of investment units in one or more of said plurality of innovations; and
prioritize said plurality of innovations based on said investments.

21. A system for managing intellectual capital in an enterprise, comprising:
a memory; and
at least one processor, coupled to the memory, operative to:
obtain a description of a plurality of innovations of said enterprise;
provide said descriptions to a plurality of employees;
allow said plurality of employees to record contributions to said innovations in records associated with said description; and
provide said descriptions and an indication of said corresponding contributions to a plurality of employees.
